(19) United States
(12) Patent Application Publication
(10) Pub. No.: US 2026/0160987 A1
(43) Pub. Date: Jun. 11, 2026

(54) SYSTEMS AND METHODS FOR THREE-DIMENSIONAL STRUCTURED ILLUMINATION MICROSCOPY WITH ISOTROPIC SPATIAL RESOLUTION IMPROVEMENT OF AXIAL RESOLUTION IN 3D SIM VIA OPTICAL AND COMPUTATIONAL MEANS

(71) Applicants: The USA, as represented by the Secretary, Department of Health and Human Services, Bethesda, MD (US); The University of Chicago, Chicago, IL (US)

(72) Inventors: Hari Peng SHROFF, Bethesda, MD (US); Yicong WU, Bethesda, MD (US); Patrick LA RIVIERE, Chicago, IL (US); Xuesong LI, Bethesda, MD (US)

(21) Appl. No.: 18/707,466

(22) PCT Filed: Oct. 7, 2022
(86) PCT No.: PCT/US2022/077763

§ 371 Date: May 3, 2024

Related U.S. Application Data
(60) Provisional application No. 63/275,736, filed on Nov. 4, 2021.
(60) Provisional application No. 63/297,162, filed on Jan. 6, 2022.

(51) Int. Cl. G02B 21/36; G01N 21/64; G02B 21/06; G02B 21/16

(52) U.S. Cl. CPC G02B 21/367; G01N 21/6458; G02B 21/06; G02B 21/16; G01N 2021/6463

(57) ABSTRACT

Various embodiments for a three-dimensional structured illumination microscopy system having a mirror positioned in diametric opposition to the objective for producing additional illumination components by a fourth beam generated by the mirror and a computational means for accomplishing the same are disclosed herein.

### FIELD

The present disclosure generally relates to a three-dimensional structured illumination microscopy (3D SIM) system having nearly isotropic or isotropic spatial resolution; and in particular, to systems and methods for improving spatial resolution in 3D SIM by positioning a mirror in diametric opposition to the objective lens for isolating the central illumination beam in the 3D SIM optical system that creates a four-beam interference pattern for increasing axial spatial resolution.

### BACKGROUND

Three-dimensional structured illumination microscopy (3D SIM) provides optically sectioned super-resolution microscopy with ˜two-fold better resolution than widefield fluorescence microscopy in all three spatial dimensions. This capability is enabled by periodic, diffraction-limited illumination structure introduced to the sample, typically via a single objective. Multiplication of the labeled sample with this illumination structure yields additional information outside the diffraction-limited passband that is encoded in the fluorescence captured by a series of diffraction-limited images of the sample. Such information may then be decoded mathematically to yield a super-resolution reconstruction of the sample. For thin samples, 3D SIM offers advantages relative to other forms of super-resolution microscopy (e.g. localization microscopy, stimulated emission depletion microscopy) due to its relatively low illumination dose (enabling volumetric imaging in living cells) and compatibility with arbitrary fluorophores (facilitating multicolor super-resolution imaging).

Although the resolution enhancement in the axial dimension is two-fold better than diffraction-limited widefield microscopy, the absolute axial resolution of 3D SIM is still limited to ˜300 nm using high numerical aperture (NA) optics. This is worse than the lateral resolution in diffraction-limited microscopy, and it is thus desirable to find ways of improving the axial resolution in conventional 3D SIM, ideally to the same extent as the lateral resolution.

The reason the axial resolution is worse than the lateral resolution in any conventional single-objective 3D SIM microscope is because the illumination structure is itself diffraction-limited, and thus ˜2-3 fold coarser along the axial dimension than the lateral dimension. As shown in FIG. 1A, this anisotropy in the illumination can be understood by realizing that the three illumination wave vectors (1,2, and 3) that interfere with each other to produce a 3D SIM illumination pattern lie on a spherical cap determined by the NA of the objective lens. The differences between any pair of wave vectors (1 and 2, 1 and 3, and 2 and 3) determine the spatial frequencies of the illumination. The purely lateral illumination frequencies are given by the difference between wave vectors 1 and 3 (i.e. those wave vectors that arise at the periphery of the spherical cap and whose differences are larger than the axial illumination frequencies determined by the differences between wave vectors 1 and 2 (or wave vectors 2 and 3).

FIG. 1A further shows illumination wave vectors 1, 2, and 3, while FIG. 1B shows the spatial frequency components of those illumination wave vectors 1, 2 and 3 in a conventional single objective 3D SIM microscope. FIG. 1A also shows illumination wave vectors in a conventional 3-beam SIM lying on a spherical cap determined by the NA (=n sin ⊖) of the objective lens. FIGS. 1B and 8 illustrate the respective differences between any pair of wave vectors (1 from 2, 2 from 1, 1 from 3, 3 from 1, 2 from 3, 3 from 2, or any wave vector from itself) that produce seven illumination components 150 (black dots) of the resulting illumination pattern 140, for example illumination components 150A-150C that represent the on-axis central illumination component 150A and off-axis illumination components 150B and 150C. Note that purely lateral (along the kx axis) spatial frequencies are larger than the axial spatial frequencies (those with amplitude along the kz axis), because the former are due to the larger differences between peripheral wave vectors 1 and 3, while the latter are determined by the smaller differences between central and peripheral wave vectors (1 and 2, or 2 and 3).

The above diagram, and reasoning, suggest that one method for improving axial resolution would be to increase the number of ‘axially oriented’ wave vectors in the illumination of the sample. Interference from such additional wave vectors during illumination could serve to increase the number and amplitude of spatial frequencies in the axial direction, which in turn could improve axial resolution in conventional 3D SIM.

This concept has been explored in ‘I5S’ microscopy, whereby two diametrically opposed objectives are used to introduce six mutually coherent illumination wavevectors, whose interference pattern yields 19 illumination frequency components instead of the 7 in single objective 3D SIM. The additional frequency components along the axial dimension produce axial structure as fine as the lateral structure in single objective 3D SIM. This feature, as well as the fact the fluorescence emission in I5S is also interfered coherently, yields isotropic ˜100 nm spatial resolution, more than doubling the volume resolution of 3D SIM.

However, I5S also offers several significant drawbacks that significantly hinder widespread adoption. First, the two paths for illumination and fluorescence require more optics than traditional 3D SIM, adding considerable cost and complexity to the optical system and diminishing sensitivity. Second, and more importantly, the paths must be carefully aligned, and that alignment maintained to much better than one wavelength, lest the condition for interferometry drift or be destroyed. In practice this requires active feedback of multiple optical elements, further adding to instrument complexity. Third, any degree of refractive index mismatch between sample and immersion fluid will introduce severe aberrations, limiting the technique to fixed samples. To date, these limitations have kept I5S within the province of only a handful labs; in practice the method is not used for biological research.

An interesting alternative to I5S was recently proposed, whereby the on-axis central illumination beam (corresponding to wave vector 2 in FIGS. 1A and 8) in a conventional 3D SIM microscope is captured with a low-NA objective opposite the sample, re-imaged to a mirror, and reflected back to the sample. In this way, a fourth, reflected wave vector interferes with the original 3-beam pattern, thereby yielding a 4-beam interference pattern with finer axial structure than the illumination pattern in conventional single objective 3D SIM. This method offers fewer illumination frequency components than I5S and does not interfere the fluorescence emission as in I5S. The extent of the axial resolution improvement is thus less than I5S, but in theory the improvement is still substantial compared to conventional 3D SIM; a theoretical axial resolution less than 150 nm was predicted.

However, even with this simplified setup, notable challenges exist. First, while simpler than the optical path of I5S, the optics necessary to reflect the central illumination beam still require stable alignment and add complexity relative to single-objective 3D SIM (e.g. two objectives are still required). Second, the reflected illumination beam must traverse multiple optical elements twice, adding undesirable wavefront distortion to the reflected beam. Third, such distortion will also be introduced by the different refractive index of air (the medium in which the additional optical elements are placed) and water (in which the sample is placed).

Fourth, and perhaps more importantly, the additional optical path length required would likely span almost a meter. This implies that the illumination source (a laser) must have a coherence length of at least this length, so that interference between direct and reflected beams is possible. This condition may rule out common single-mode laser sources often used in microscopy.

It is with these observations in mind, among others, that various aspects of the present disclosure were conceived and developed.

### BRIEF DESCRIPTION OF THE DRAWINGS

FIGS. 1A and 1B show an illustration of illumination wave factors and spatial frequency components in a conventional 3D-SIM arrangement.

FIG. 2A is an illustration showing a conventional 3D-SIM arrangement; FIG. 2B is an illustration showing an improved 3D SIM with a mirror arrangement; and FIG. 2C is an illustration of the optical components of the improved 3D-SIM system in relation to the mirror arrangement.

FIG. 3 is an illustration of the coverslip of the mirrored 3D-SIM in relation to the mirror arrangement showing that the geometric considerations reveal that parasitic off-axis reflection does not influence the imaging region.

FIG. 4 shows two sets of images for wide-field, conventional 3D-SIM system, and the mirrored 3D-SIM system illustrating the gaps in the optical transfer function (OTF) with different lower NA objectives.

FIG. 5 shows images and related graphical representations of the mirrored 3D-SIM system that demonstrates addition of the mirror improves axial resolution relative to the wide-field and conventional 3D-SIM systems.

FIG. 6 shows images of wide-field, conventional 3D-SIM system, and the improved 3D SIM in lateral (top) and axial (bottom) cross sections through the bacterial sample labeled with a membrane dye.

FIG. 7 shows near isotropic images of mitochondrial membranes as captured through the mirrored 3D-SIM system.

FIG. 8 shows a wavevectors/illumination component configuration for conventional 3D SIM system illustrated in FIG. 1B.

FIG. 9 shows a wavevectors/illumination component configuration for the mirrored 3D-SIM system.

FIG. 10A illustrates a computational method for generating training data having high/low resolution image pairs; and FIG. 10B illustrates a training model for a neural network to improve axial resolution by inputting training set image data into a neural network.

FIG. 11 illustrates resolution recovery of 3D-SIM images at different orientations using the trained neural network.

FIG. 12 illustrates 3D-SIM image data rotated along different orientations being passed through the trained neural network to generate a predicted reconstruction with improved isotropic resolution.

FIGS. 13A-13D are 3D-SIM images that compare the axial resolution improvement process for improving axial resolution to 3D-SIM image input with other conventional methods of improving axial resolution.

FIG. 14 is a simplified block diagram showing an exemplary computing system for effectuating the functionalities of the axial resolution improvement method of improving axial resolution in 3D-SIM images.

FIG. 15 is a process flow for generating training set data and subsequent training using the neural network using the generated training set data shown in FIGS. 10A and 10B.

FIG. 16 is a process flow for resolution recovery at different rotations of the 3D-SIM image data shown in FIG. 11.

FIG. 17 is a process flow for combination of six different rotations of the 3D-SIM image data shown in FIG. 12.

FIGS. 18A-18D provide test data including image data and graphical representations regarding the improvement in axial resolution in three-dimensional structured illumination microscopy on an inorganic sample (100 nm fluorescent beads).

FIGS. 19A-19I provide test data including image data and graphical representations regarding the improvement in axial resolution in 4-beam structured illumination microscopy that enables near-isotropic imaging of an organic sample.

FIGS. 20A-20J provide test data including image data and graphical representations regarding the improvement in axial resolution in the deep learning framework using computational means.

Corresponding reference characters indicate corresponding elements among the view of the drawings. The headings used in the figures do not limit the scope of the claims.

### DETAILED DESCRIPTION

The present disclosure is directed to an optical system and method for generating 4-beam interference in single-objective 3D-SIM system that requires the strategic positioning of only a single additional optical element—a mirror—to a conventional 3D-SIM. Various embodiments for a mirrored single-objective 3D-SIM system having an optical element for introducing additional illumination components through an on-axis reflected illumination beam generated by addition of the mirror being positioned in direct opposition to the objective are disclosed herein. In one aspect, images generated by the mirrored 3D-SIM system produced from the 4-beam interference pattern possess higher axial spatial frequencies that conventional 3D-SIM that produces only 3-beam interference. This system and method is fully compatible with conventional diode lasers as illumination sources and enables axial resolution down to ˜140 nm, more than doubling the axial resolution of a conventional single-objective 3D-SIM system.

The present disclosure is also directed to a computational system and method for extending and improving axial resolution in 3D-SIM image data. In one aspect, the system and method can generate training data used as input to a train a neural network to predict and reconstruct an image with improved axial resolution. In one aspect, degraded resolution data from the training data in conjunction with smoothed (slightly blurred) 3D SIM data (ground truth) generates low/high resolution training pairs used to train the neural network to reverse the effects of pixelization and degraded lateral resolution in a 3D-SIM image evaluated by the trained neural network. After application of the trained neural network, resolution is improved along a lateral direction, for example along the X-axis. The trained neural network may then be applied to additional blurred 3D SIM image data rotated along different orientations. After applying the neural network, the rotated image data may be rotated back into the original frame, thereby improving axial resolution along different directions. Finally, 3D-SIM image data rotated along six (or more) different directions may be passed through the trained neural network, Fourier transformed, the maximum value at each pixel in frequency space saved, and the result inverse Fourier transformed to generate a 3D-SIM reconstruction having isotropic resolution.

### Optical System

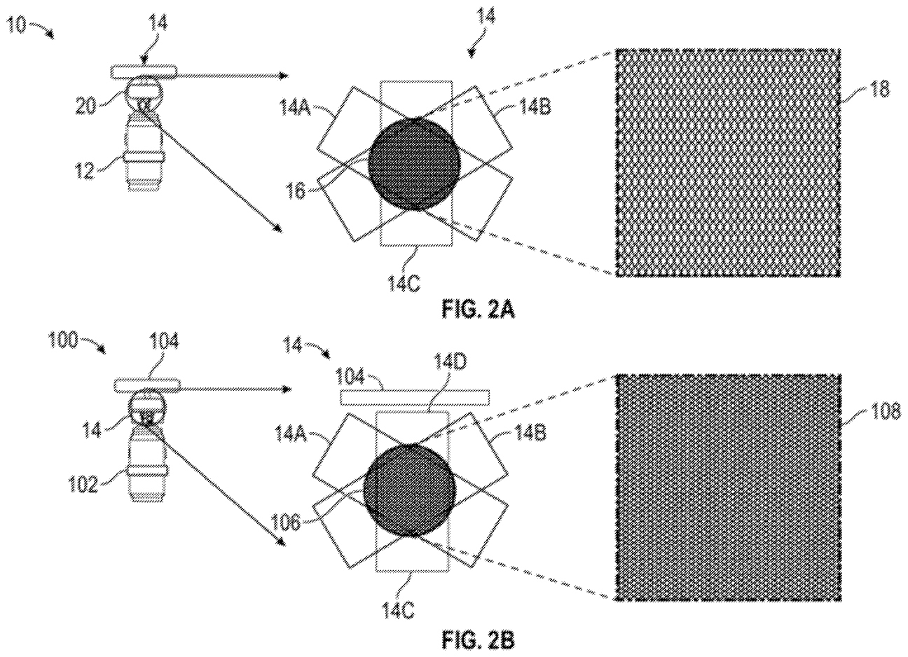

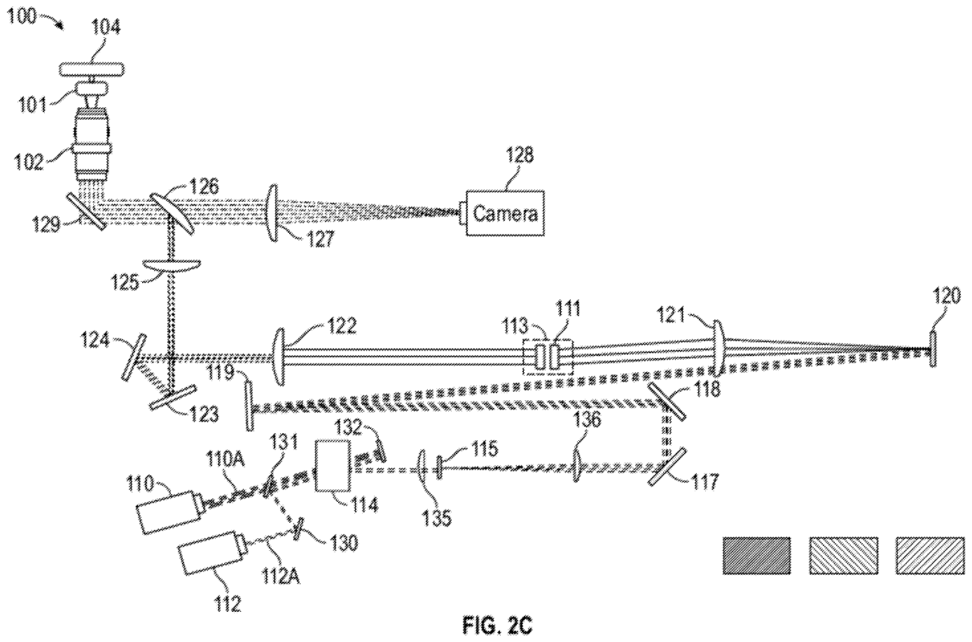

One key insight that enables the mirrored 3D-SIM system and method of the inventive concept to improve axial resolution is that the mirror positioned in diametric opposition to the objective lens allows an on-axis reflected fourth illumination beam to be generated from the on-axis central illumination beam, thereby producing a 4-beam illumination interference pattern (FIG. 2B) from the mirrored 3D-SIM system of the present disclosure.

FIG. 2B shows that positioning a mirror 104 in direct opposition to an objective 102 for a single-objective 3D-SIM system 100 introduces a finer axial illumination structure than the conventional single-objective 3D SIM 10 (FIG. 2A). As shown in FIG. 2A, a conventional 3D-SIM system 10 produces three mutually coherent illumination beams, 14A, 14B and 14C, focused at the back focal plane of a high NA objective lens 12 that produces three-beam interference 16 at the sample 20 to generate an axial illumination pattern 18. Note that axial extent of illumination foci is larger than lateral extent, thereby resulting in anisotropic spatial resolution.

Referring to FIG. 2B, the mirrored 3D-SIM system 100 of the present disclosure includes a mirror 104 positioned diametrically opposite an objective lens 102 such that the on-axis central illumination beam 14C from the objective lens 102 is reflected by the mirror 104 directly back towards the sample 101 and objective lens 102 as an on-axis reflected illumination beam 14D, thereby resulting in a 4-beam interference pattern 106 having a finer axial structure generated by the interference collectively produced by the four illumination beams 14A-14D. For example, off-axis illumination beams 14A and 14B may illuminate the sample 101 at an off-axis angle relative to the sample 101, while the on-axis central illumination beam 14C illuminates the sample 101 axially, for example, at a 56° angle relative to off-axis illumination beams 14A and 14B. In addition, a portion of the on-axis central illumination beam 14C is reflected by the mirror 104 back to the sample 101, as on-axis reflected illumination beam 14D, in a direction directly opposite to on-axis central illumination beam 14C, which generates the 4-beam interference pattern 106 that produces an axial illumination pattern 108. A comparison of the axial illumination pattern 108 generated by 4-beam interference pattern 106 produced by the mirrored 3D-SIM system 100 with the axial illumination pattern 18 generated by the 3-beam interference pattern 16 produced by the conventional 3D-SIM system 10 shows that the four-beam interference pattern 106 has better resolution along the z-axis than the axial interference pattern 18 by virtue of the on-axis reflected illumination beam 14D produced when the on-axis central illumination beam 14C reflects off a mirror 104 positioned in diametric opposition to the objective lens 102. The mirrored 3D-SIM system 100 modified in the manner described herein has the capability to yield a reconstruction with better (more than 2-fold) axial resolution improvement compared to conventional 3D SIM system 10.

Referring to FIG. 2C, one embodiment of the mirrored 3D-SIM system 100 is operable for generating a four-beam illumination that produces a four-beam interference pattern with increased axial resolution. In one embodiment, the mirrored 3D-SIM system 100 may include a first illumination source 110 for generating a first laser beam 110A (e.g, λ=561 nm) through an acousto-optic tunable filter 114 (AOTF) and a second illumination source 112 for transmitting a second laser beam 112A (e.g., λ=488 nm) that is reflected off first mirror 130 and combined with laser beam 110A via a dichroic mirror 131 before passing through the AOTF 114, which transmits the combined laser beam through a beam expander comprising a first lens 135 and a second lens 136 after being spatially filtered with pinhole 115. A beam dump 132 may be used to block unwanted illumination through the AOTF 114. The expanded laser beam is then reflected off a pair of mirrors 117 and 118 to another mirror 119 that reflects the expanded laser beam to a spatial light modulator (SLM) 120, such as a Meadowlark, MSP1920 device.

In one embodiment, the SLM 120 generates a three-beam illumination pattern having five phases and three orientations for a total of 15 images. The three-beam illumination patterns are Fourier transformed through lens 121 (f3) and filtered through a pupil mask 113 to remove spurious illumination patterns produced by the SLM 120, passing only three beamlets that are re-imaged to the back focal plane of the objective lens 102 via a telescope produced by lens 122 (f4 ) and lens 125 (f5), thereby producing high contrast interference patterns at the plane of the sample 101. In some embodiments, a liquid crystal polarization rotator 111 (LCPR) is used to rotate the polarization of the three beamlets to maximize interference contrast at the sample plane. In some embodiments, a pair of mirrors 123 and 124 redirect the three illumination beams to a dichroic mirror 126 operable to separate the three illumination beams from the resultant fluorescence emissions emitted from the sample 101 after excitation. In some embodiments, a mirror 129 may be optically interposed between the dichroic mirror 126 and the objective lens 102 for redirecting the illumination beams though the objective lens 102. In some embodiments, the objective lens 102 may be a 1.35 NA objective lens. As noted above, a mirror 104 is positioned in diametric opposition to the objective lens 102 with the sample 101 positioned between the mirror 104 and the objective lens 102 such that the on-axis central illumination beam 14C is reflected directly back toward the sample 101 as an on-axis reflected illumination beam 14D and a four-beam interference pattern 108 is generated at the plane of the sample 101.

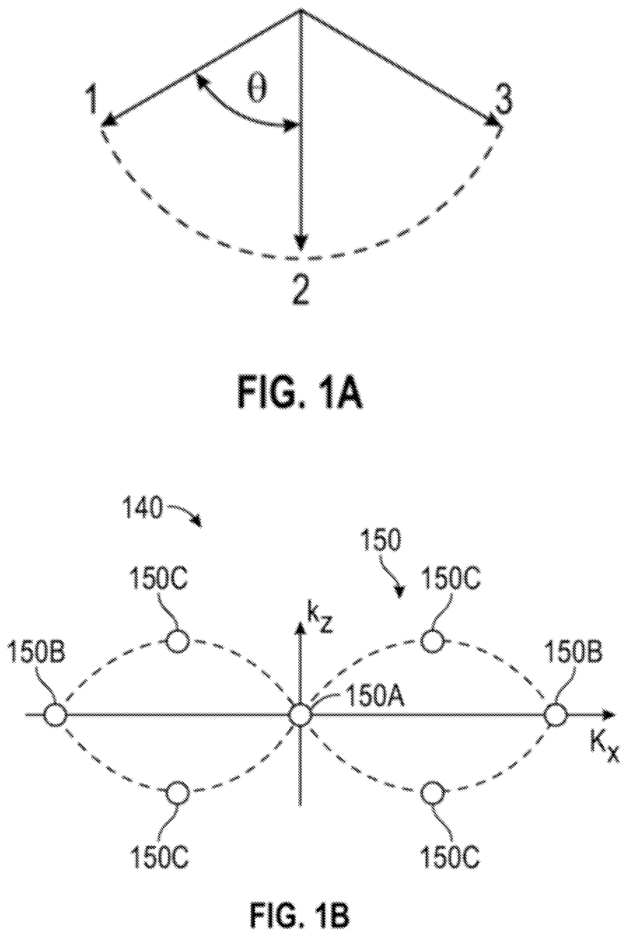

Although the mirror 104 obviously reflects the on-axis illumination beam (wave vector 2 in FIG. 1), it is reasonable to wonder if there is parasitic reflection from the off-axis beams (wave vectors 1 and 3 in FIG. 1) that would contaminate the interference pattern. After all, this is presumably why earlier efforts to introduce 4-beam interference proposed a more complex optical arrangement to isolate and reflect only the on-axis central illumination beam 14C.

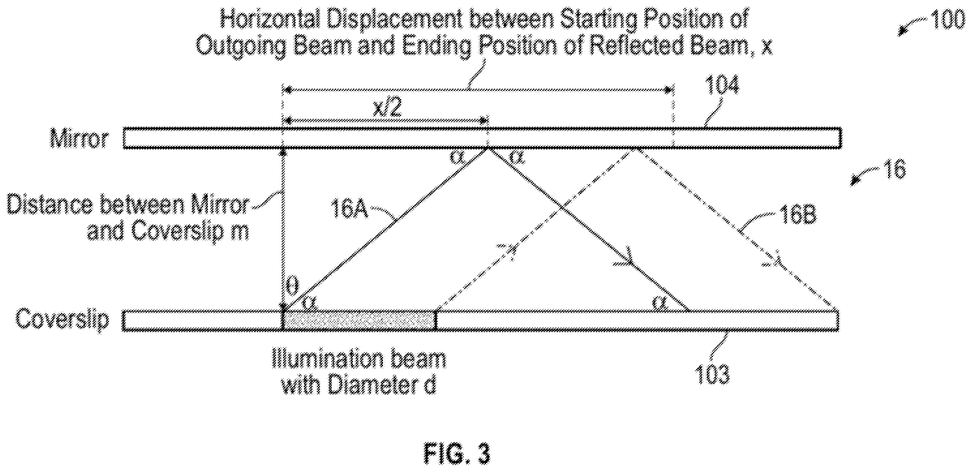

Examining the geometry in the vicinity of the coverslip 103 and mirror 104 (FIG. 3) reveals that this is not a concern for the highly angled off-axis illumination beams produced at the high numerical apertures used for 3D-SIM, as the reflected beams are displaced more than a mm compared to the ˜100 μm beam diameter typically used in in our illumination system.

FIG. 3 is a simplified illustration showing that geometric considerations reveal parasitic off-axis reflection does not occur. Consider incoming illumination beams 105 with diameter d. While the on-axis central illumination beam 14C is reflected back towards the source (e.g., sample) as the on-axis reflected illumination beam 14D, what about the off-axis illumination beams, for example by rays 16A and 16B. Consider the blue rays (solid and dashed) 16A/16B which bound one of the off-axis illumination beam 14B from symmetry the same analysis applies for the other off-axis illumination beam 14A, not shown in FIG. 3 for clarity. Subsequent geometric analysis shows that the reflected, off-axis illumination beams 14A/14B is displaced a horizontal distance x=2 m/tan α, where m is the distance between mirror 104 and coverslip 103 and α is the angle of the illumination beams 14A/14B relative to the coverslip 103 (which is related to the NA=n sin ⊖ of the illumination by α=π/2−⊖). In the present mirrored 3D-SIM system 100, an objective 102 with NA=1.35 is used, off-axis illumination beams 14A/14B entering at ˜90% of the back focal plane pupil, m=500 μm, and d=100 μm. With these parameters, x=1.8 mm, i.e. the off-axis reflection of the illumination beams 14A/14B impinges back upon the sample 101 quite far from the location of the incoming illumination beam 14.

With these considerations in mind, collection of the raw data required for implementation of the mirrored 3D-SIM system 100 with improved axial resolution proceeds as in conventional 3D-SIM system 10:5 images with illumination patterns phase shifted 2π/5 relative to each other are collected, and this procedure is repeated for two additional orientations of the illumination pattern (the three orientations are rotated 60 degrees with respect to another). Reconstruction of the final super-resolved image also proceeds as in a conventional 3D-SIM system 10.

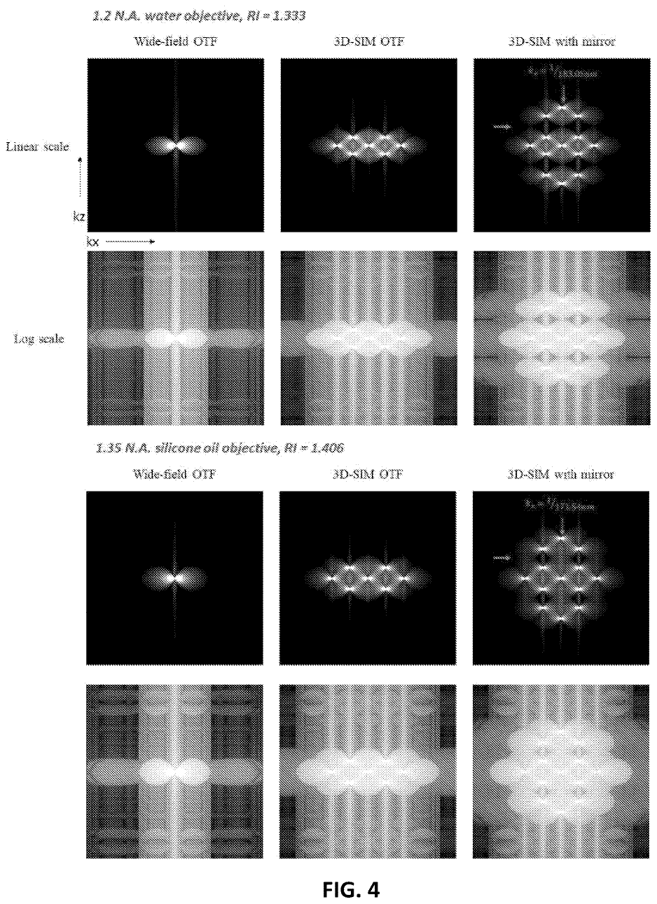

The following additional considerations were found to be important in successfully implementing a 4-beam, mirrored 3D-SIM system 100. A desirable feature in any imaging system is that its optical transfer function (OTF) is free of zeros up to the resolution limit (i.e. no zeros in the ‘passband’ of the imaging system). Although the 4-beam illumination pattern does introduce additional illumination components relative to conventional 3D SIM system 10, allowing the potential for higher resolution, the overall OTF support of the imaging system is still determined by the convolution of this pattern with the widefield OTF. Thus, the illumination and detection NA determine the precise position of the illumination spatial components, the widefield OTF, and the resulting 4-beam SIM OTF. To ensure no ‘gaps’ in the OTF support, a somewhat higher illumination NA is required than for conventional 3D-SIM system 10, i.e. as shown in FIG. 4A, a 1.2 NA water lens imaging into water (previously employed in 3D-SIM system 10) does not fully fill the gaps (blue arrows) in the transfer function, whereas a 1.35 NA silicone oil lens imaging into n=1.406 media (the refractive index of the corresponding silicone immersion oil) does as shown in FIG. 4B. Several commercially objectives were numerically evaluated that ‘work’ for a 4-beam configuration (1.27 NA, 1.35 NA, 1.42 NA all with off-axis beamlets entering the objective at ˜90% of the pupil radius) and we have tested the 1.35 NA system successfully.

FIG. 4 shows images of gaps in the OTF with lower NA objectives. OTFs are shown in linear and log scales for two microscope configurations: a 1.2 NA water lens imaging into water (FIG. 4A), and a silicone oil objective imaging into media with the same refractive index as silicone oil (FIG. 4B). Although both systems offer similar maximum axial spatial frequency (red arrow, numbers), in the 1.2 NA configuration the additional OTF support provided by the mirrored reflection of the on-axis beam is displaced axially from the 3D-SIM OTF support (blue arrows, especially evident in log scale comparisons). Imaging with the 1.2 NA configuration would thus result in loss of contrast and artifacts at these ‘missing’ spatial frequencies.

A major advantage of the mirrored 3D-SIM system 100 disclosed herein over I5S is that the interference need be kept stable only over the ˜1 mm path difference of the reflected illumination beam 14D relative to the incoming illumination beams (i.e. 0.5 mm from coverslip 103 to mirror 104 and 0.5 mm from mirror 104 back to coverslip 103 illustrated in FIG. 3). Similarly, the coherence length of the laser only needs to be the same as round-trip distance, thereby allowing the use of many readily available illumination sources 110 and 112.

It was still found that active stabilization is useful in preventing relative drift between the coverslip 103 and mirror 104, and in properly positioning the maxima of the standing wave with respect to the focal plane of the objective lens 102. To achieve both goals, 100 nm fluorescent beads were scattered on the coverslip 103 and (1) their axial position estimated to correct focal drift by moving the sample stage so that the bead position is maintained; and (2) the beads were used to find the maxima of the standing wave pattern, adjusting the position of the mirror 104 with a piezoelectric device to minimize drift of the maxima with respect to the focal plane. By periodically inspecting the fluorescent beads and applying corrective movements of the sample stage or mirror 104, it was found that drift can be minimized to less than 20 nm.

Index mismatches between the sample 101, media, and immersion oil lead to depth-dependent spherical aberration and an apparent focal shift in the imaging plane. These effects lower resolution and contrast in 3D-SIM, leading to artifacts in the reconstruction. Such artifacts are exacerbated in the 4-beam single objective 3D-SIM configuration as disclosed herein and should be minimized. One strategy, at least in fixed samples, is to match the refractive index of the sample/media to the refractive index of the immersion oil. When using the 1.35 NA silicone oil objective, an effective solution is to introduce iodixanol at ˜45% final concentration, thereby altering the refractive index to 1.406, the same as the silicone oil immersion fluid. It was also hypothesized that using a commercially available 1.27 water immersion lens would minimize spherical aberration when imaging into aqueous specimens, although this has not been verified.

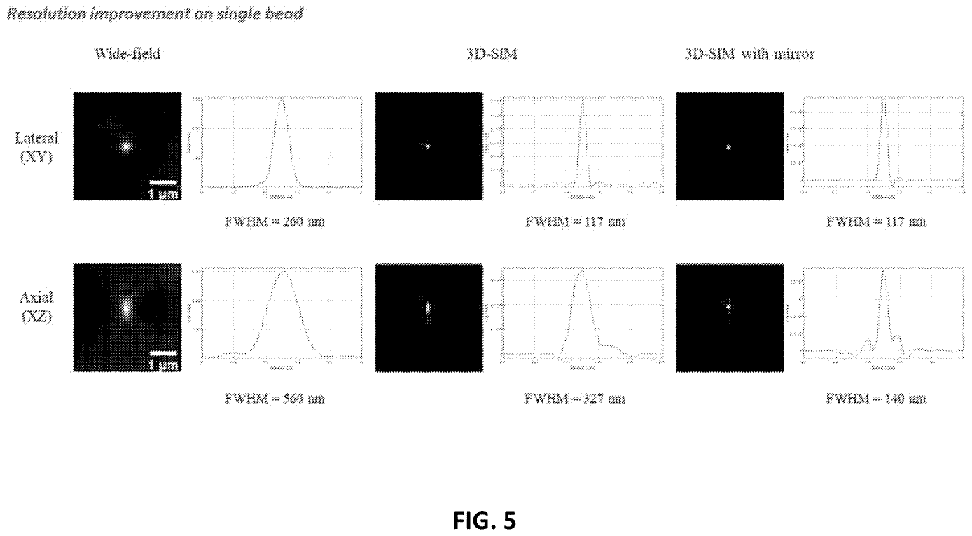

The working prototype demonstrates the addition of a diametrically opposing piezoelectrically mounted mirror as described above with a mirrored 3D-SIM system 100 improves axial resolution more than two-fold relative to the ‘base’ 3D SIM system (FIGS. 5-7).

FIG. 5 shows images of 100 nm fluorescent beads and related graphical representations that compare wide field, 3D-SIM system 10, and the mirrored 3D-SIM system 100 having the added mirror 104 positioned in diametric opposition to the objective lens 102. It was discovered that adding a mirror 104 to a conventional 3D-SIM system 10 in such a manner enhances axial resolution more than 2-fold. Images of 100 nm beads, as visualized in widefield (left), 3D SIM (middle), and the mirrored 3D-SIM system 100 (right). Lateral (top) and axial (bottom) cross sections are shown. Addition of the mirror 104 as described above was found to improve axial resolution (to ˜140 nm, compared to ˜327 nm) relative to 3D SIM, without compromising lateral resolution.

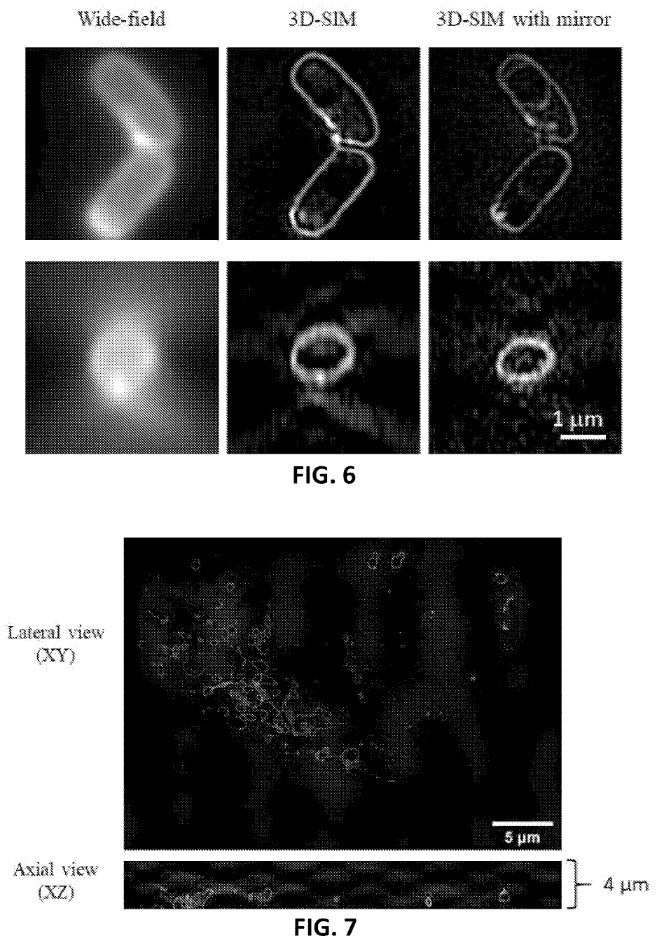

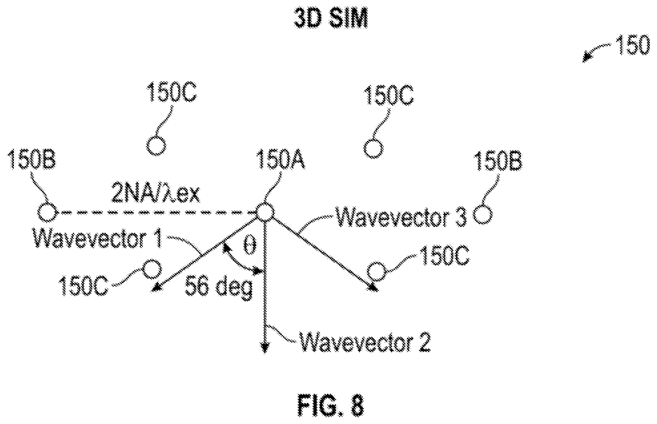

FIG. 6 shows the axial resolution improvement on membrane labeled bacteria. Lateral (top) and axial (bottom) cross sections through B. subtilis labeled with membrane dye. Note the improved axial resolution offered by the 3D SIM system 100 compared to the 3D SIM or widefield images.

FIG. 7 shows near isotropic images of mitochondrial membranes, as captured with the mirrored 3D-SIM system 100. U2OS cells were fixed and the outer mitochondrial membranes immunolabeled and imaged in the prototype system. Lateral (top) and axial (bottom) images are shown. No obvious anisotropy in resolution is evident in axial views.

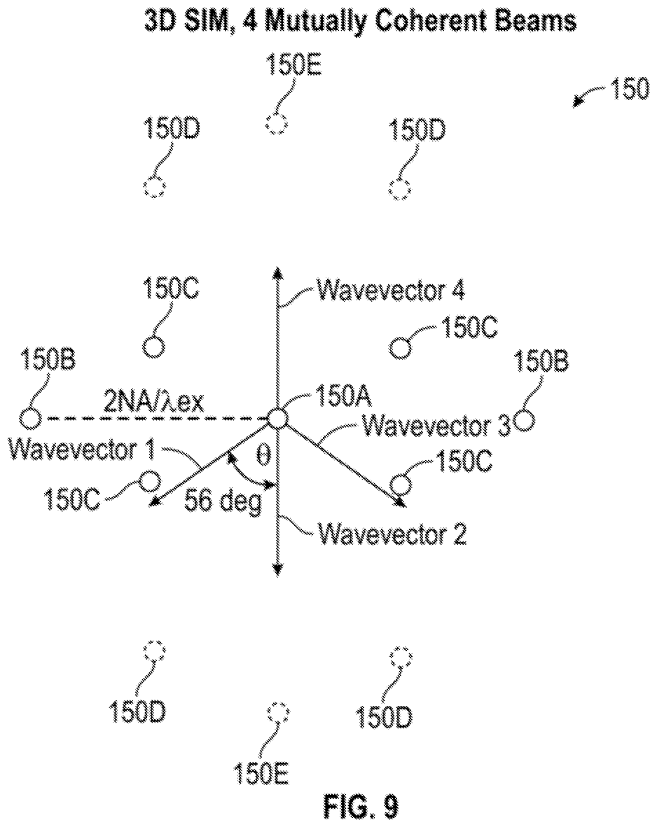

FIG. 9 shows the illumination components 150 produced by the mirrored 3D-SIM system 100 of FIGS. 2B and 2C. In this arrangement, illumination components 150D and 150E are produced in addition to illumination components 150A-150C generated by the four mutually coherent illumination beams of the mirrored 3D-SIM system 100. The illumination components 150A-150E generate the axial illumination pattern 108 (FIG. 2B) with increased axial resolution over the conventional 3D-SIM system 10.

### Computational System

Although an optical method for improving axial resolution does not require more raw images per plane than conventional 3D SIM (3 orientations×5 phases=15 images), Nyquist sampling the improved axial resolution demands an axial step at least twice as fine as the resolution (i.e. ˜60 nm). This implies a larger number of raw images are required for even a modestly sized stack, e.g. to interrogate a 6 μm thick volume of a sample spanning a single cell would require 100×15=1500 raw images. While tolerable for brightly labeled, fixed samples, the large number of images introduces significant photobleaching/photodamage when imaging live samples. An additional problem is that the typical Wiener deconvolution step used to produce the final reconstruction from the input raw data is very sensitive to noise, and typically fails at low illumination levels (which lessen photodamage and preserve sample health). As such, alternate methods are required to 1) improve axial resolution of the sample and 2) lower illumination dose applied to the sample. Importantly, neither of these two improvements requires any specialized optical equipment and can be implemented with a conventional 3D SIM system. In addition, these improvements can be used in combination to greatly lower illumination dose while simultaneously improving axial resolution.

In another aspect, an axial resolution improvement process is disclosed comprising a deep learning method for reducing the number of images required for two-dimensional resolution enhancement of a 3D-SIM image as disclosed below. The present inventive concept involves gathering multiple 3D-SIM image training pairs, each consisting of smoothed 3D SIM image data and the same data blurred and downsampled along one or more directions. The deep learning method applies these image data pairs to train the neural network such that the trained neural network is capable to predict and restore the resolution lost by blurring based on an evaluation of the blurred input. In addition, the method digitally rotates the blurred image data input along different orientations before passing these rotated images through the trained network. The method may also combine such rotated, super-resolved predictions into one global prediction, reconstructing an image volume with isotropic resolution.

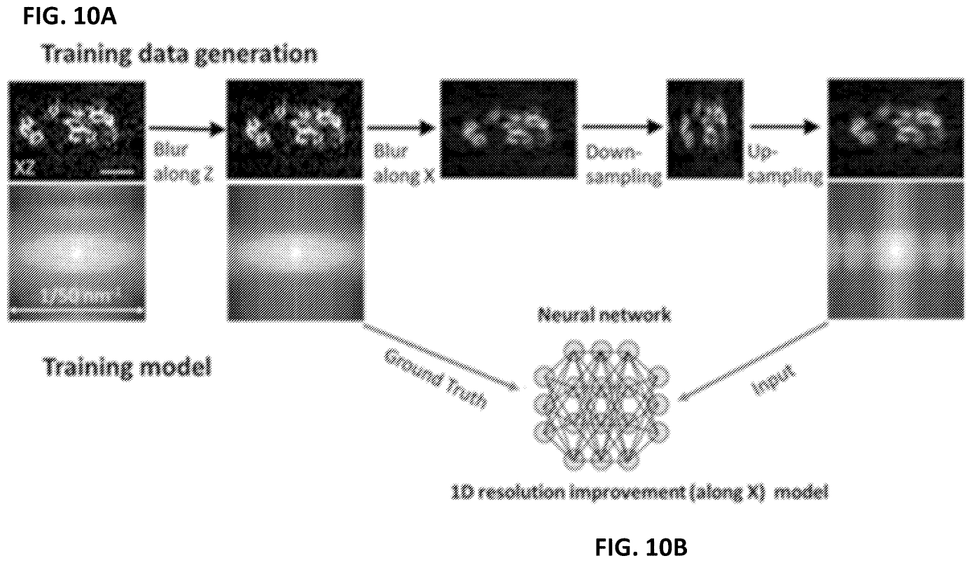

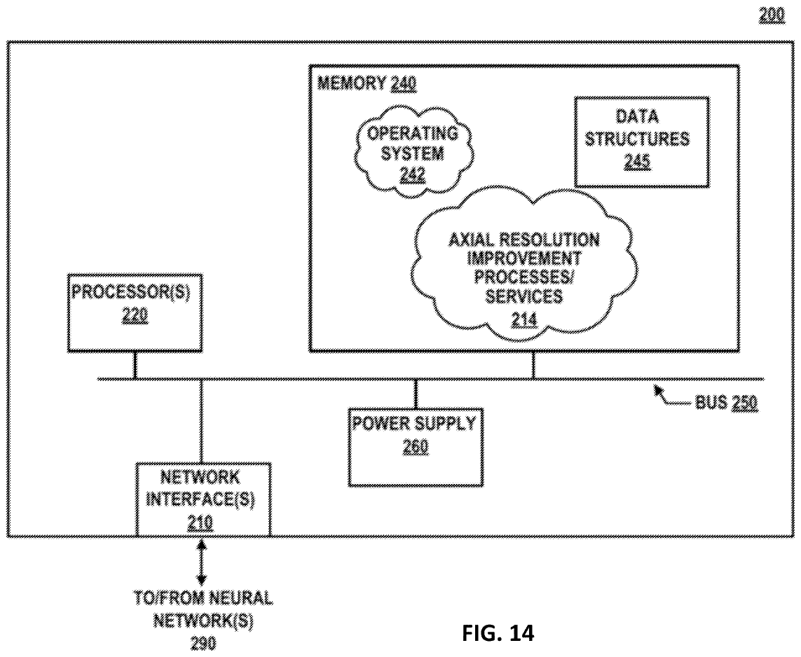

FIG. 10A illustrates the resolution improvement process 214 (FIG. 14) for improving axial resolution in 3D-SIM image data by training a neural network to predict and restore resolution in a blurred 3D SIM image evaluated by the trained neural network. For example, 3D-SIM image data can be visualized along ‘lateral-axial’ two-dimensional cross-sectional views such as in the X-Z plane view, although other views, such as the Y-Z view, are contemplated by the present system and method. To develop a training set for input into the neural network, image data from 3D SIM images may be i) blurred along the Z (axial) axis to smooth background (i.e., blur the data along the z direction with a Gaussian kernel, σ=1.7 pixels) and eliminate spurious artifacts due to oversampling in the axial direction; ii) blurred along the X (lateral) axis (i.e., blur the data along the x direction with a Gaussian kernel σ=2.3 pixels) to generate isotropic, but low resolution data having a resolution similar to the axial resolution in a 3D SIM image; iii) downsampled to introduce pixelization similar to the poorer axial sampling in 3D SIM; and then iv) upsampled to generate data with isotropic pixel size. Downsampling and upsampling factors are both 2.5. This process is repeated to generate a plurality of high resolution and low resolution training pairs that are used as input to train the neural network to predict and digitally reconstruct a 3D-SIM image having improved resolution based on the evaluation of a degraded 3D-SIM image.

FIG. 10B illustrates the method of training the neural network using the generated 3D-SIM training pairs. In some embodiments, to train the neural network, the 3D-SIM image viewed along, for example, the X-Z axis, is blurred along the Z axis and is used as the ground truth of the 3D-SIM image training pair and represents a one-dimensional enhanced resolved image (i.e., the high resolution image). That same 3D-SIM image that has been blurred along the Z axis is then subsequently blurred along the X axis, downsampled, and then upsampled and used as the corresponding input into the neural network that represents an image degraded along the X-Z at a particular orientation (i.e., the low resolution image).

These low/high resolution image pairs are used as input to train the neural network to reverse the effects of pixelization and degraded lateral resolution. The trained network can then be used to improve resolution along an arbitrary direction (e.g. the axial direction) depending on its orientation, when the trained neural network evaluates a low resolution image.

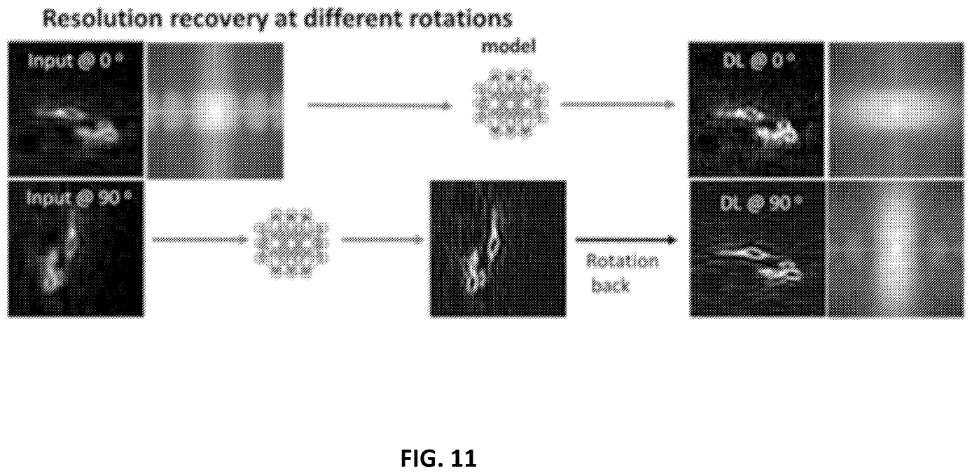

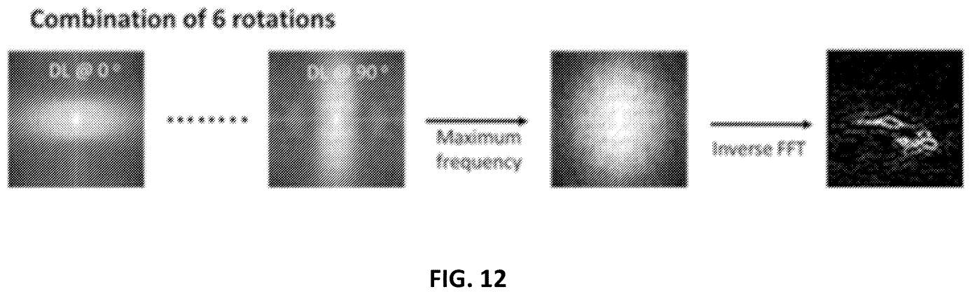

As shown in FIG. 11, the trained neural network may then be applied to additional blurred 3D SIM image data that has been rotated along different directions (for example, 0 degrees and 90 degrees as shown). After applying the trained neural network, the 3D-SIM image data is rotated back into the original frame, thereby improving resolution along different directions. In a further aspect, FIG. 12 shows that degraded 3D-SIM image data may be rotated along six different directions, and each direction passed through the trained neural network. After Fourier transforming the results, the maximum value (taken over all six rotations) at each pixel in frequency space may be saved, and the result inverse Fourier transformed to generate a reconstruction with improved axial (and isotropic) resolution as shall be discussed in greater detail below.

For example, consider X-Z or Y-Z views of the 3D SIM imaging volume. First, the 3D SIM image data is blurred along a lateral (e.g. X or Y) direction, producing 3D-SIM images with isotropic, but degraded, spatial resolution equivalent to the axial (Z) resolution in 3D SIM (FIG. 10A). This step also includes a downsampling and subsequent upsampling operation to mimic the lower sampling along the axial (Z) direct that is common in imaging. Second, based on ground truth 3D SIM image data, a neural network (e.g., content aware restoration (CARE) network based on a 3D U-net, although the choice of network is not critical) is trained to reverse this blur, retrieving lateral resolution (FIG. 10B). Third, the isotropic 3D-SIM image volume with degraded resolution is rotated about the Y (or X) axis, passing the rotated image volume through the neural network to improve resolution. By rotating the 3D-SIM images with improved resolution back into the original reference frame, the present system can produce resolution enhancement along an arbitrary direction (FIG. 11). Finally, combining all such rotated, resolution-enhanced images, e.g., by taking the maximum value of all rotations at each pixel in frequency space, the trained neural network can produce an isotropic resolution enhancement shown in FIG. 12.

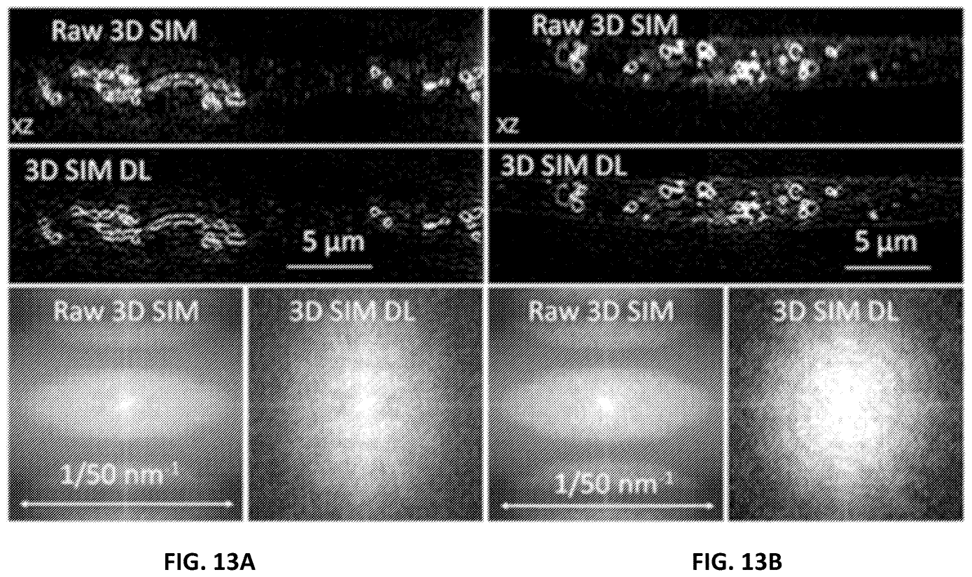

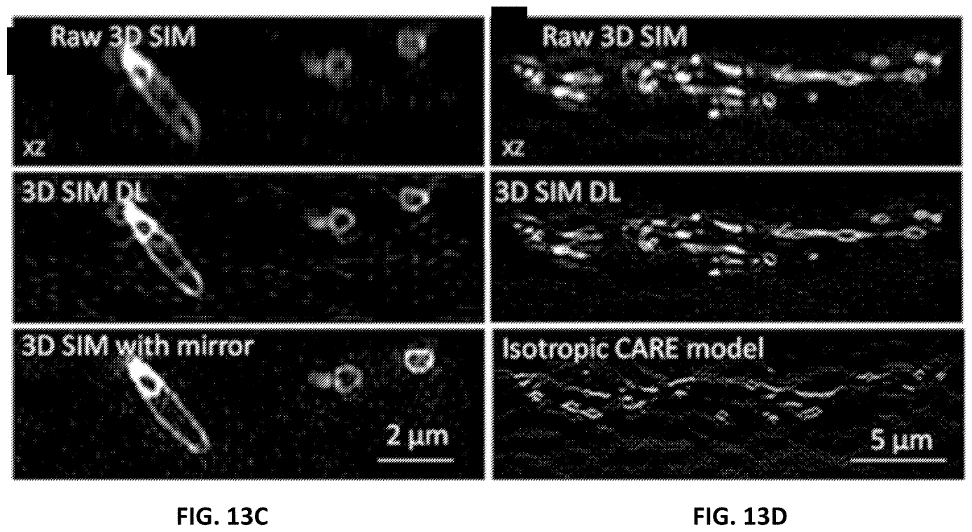

Experiments were conducted on multiple biological samples, showing that a trained neural network 290 (FIG. 14) could improve axial resolution in each case (FIGS. 13A-13D, with only modest amounts of training data (˜20-50 volumes/sample). For example, the present method blurred the lateral X-Y view to resemble the Z view, trained a neural network to reverse this blur through a predicted reconstruction with improved resolution along the Z axis. Finally, the trained neural network was applied to various rotated views oriented along different directions that are combined to produce a 3D SIM image with isotropic spatial resolution (FIG. 13, ‘3D SIM DL’).

FIGS. 13A-13D shows images comparing the present system for improving axial resolution to 3D SIM input compared with other methods of improving axial resolution. FIGS. 13A and 13B show fixed and immunolabeled U2OS cells were stained for Tomm20 a) or lysosomes b), imaged in 3D SIM (upper) and the same data passed through the computational deep learning pipeline (lower) of FIG. 13. Fourier transforms in third row confirm improved axial resolution after computational pipeline. FIG. 13C shows B. Subtilis (bacteria) were stained with a membrane dye and imaged in 3D SIM (top), after the proposed computational deep learning pipeline (middle), or with a mirror added to improve axial resolution by optical means (bottom). Note that both the computational (middle) and optical (lower) methods result in improved axial resolution relative to conventional 3D-SIM result (top). FIG. 13D shows live U2OS cells were stained with Mitotracker Green and imaged in 3D-SIM mode (top), passed through the computational pipeline (middle) or passed through prior art, the isotropic CARE model (bottom). Based on these results, it was found that the trained neural network 290 of the present system improves resolution, while the prior art over-emphasizes axial spatial frequencies and distorts mitochondrial shape.

FIG. 14 is a schematic block diagram of an example computing system 200 that may be used with one or more embodiments described herein, e.g., as a component for improving axial resolution for improving axial resolution in 3D-SIM images by the trained neural network 290. In some embodiments, the computing system 200 comprises one or more network interfaces 210 (e.g., wired, wireless, PLC, etc.), at least one processor 220, and a memory 240 interconnected by a system bus 250, as well as a power supply 260 (e.g., battery, plug-in, etc.).

Network interface(s) 210 include the mechanical, electrical, and signaling circuitry for communicating data over the communication links coupled to a communication network. Network interfaces 210 are configured to transmit and/or receive data using a variety of different communication protocols. As illustrated, the box representing network interfaces 210 is shown for simplicity, and it is appreciated that such interfaces may represent different types of network connections such as wireless and wired (physical) connections. Network interfaces 210 are shown separately from power supply 260, however it is appreciated that the interfaces that support PLC protocols may communicate through power supply 260 and/or may be an integral component coupled to power supply 260.

Memory 240 includes a plurality of storage locations that are addressable by processor 220 and network interfaces 210 for storing software programs and data structures associated with the embodiments described herein for training one or more neural networks 290 to generate predicted 3D-SIM images having improved axial resolution based on a degraded 3D-SIM image as disclosed herein. In some embodiments, the computing system 200 may have limited memory or no memory (e.g., no memory for storage other than for programs/processes operating on the device and associated caches).

The processor 220 comprises hardware elements or logic adapted to execute the software programs (e.g., instructions) and manipulate data structures 245. An operating system 242, portions of which are typically resident in memory 240 and executed by the processor, functionally organizes device 200 by, inter alia, invoking operations in support of software processes and/or services executing on the device. These software processes and/or services may include axial resolution improvement processes/services 214 which enables execution of method 200 described herein for training a neural network to generate a predicted image reconstruction with improved axial resolution based a degraded image input into the neural network 290. Note that while axial resolution improvement processes/services 214 is illustrated in centralized memory 240, wherein alternative embodiments provide for the process to be operated within the network interfaces 210, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the axial resolution improvement processes/services 214 is shown as a standalone process, those skilled in the art will appreciate that this process may be executed as a routine or module within other processes.

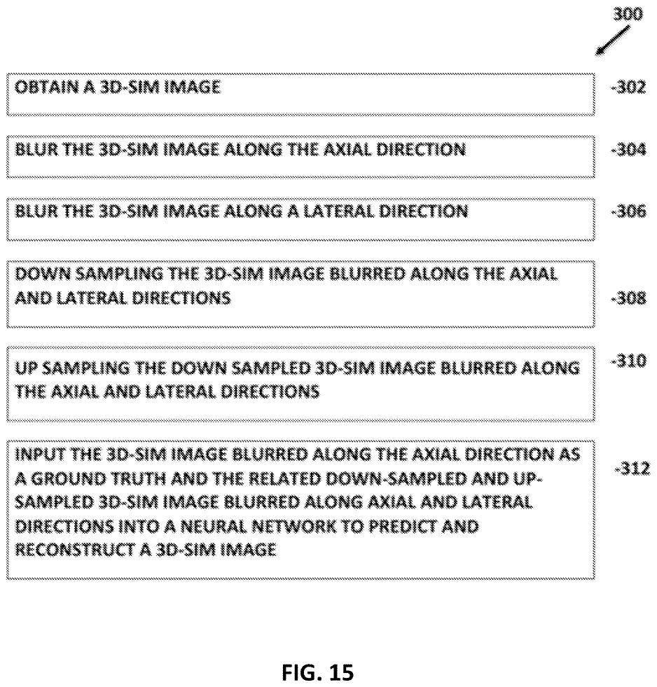

Referring to FIGS. 10A and 15, a process flow 300 is shown for the execution of the axial resolution improvement process/services 214 of computing system 200 to generate a training set of 3D-SIM image pairs (ground truth image and related degraded image) for training a neural network 290 to predict and reverse the effects of pixelization and degraded lateral resolution. At block 302, the processor 220 obtains a real 3D-SIM image. At block 304, the processor 220 blurs the 3D-SIM image along the Z axis to remove artifacts and side lobes from the 3D-SIM image and smooth the background of the 3D-SIM image to produce a high resolution 3D-SIM image. At block 306, the processor 220 blurs the 3D-SIM image along the X axis to generate isotropic but low-resolution image data having a low-resolution image data similar to the axial resolution found in 3D-SIM. At block 308, the processor 220 downsamples the 3D-SIM image blurred along the X and Z axes to introduce pixelization similar to the poorer axial sampling in the 3D-SIM image data. Once downsampled, the 3D-SIM image is then upsampled by the processor 220 at block 310 to generate 3D-SIM image data with isotropic pixel size to produce a high resolution 3D-SIM image. At block 312, after the 3D-SIM image is downsampled and upsampled, the processor 220, may input the high resolution 3D-SIM image blurred along the Z axis as a ground truth in conjunction with the related low resolution 3D-SIM image blurred along X-Z axes to generate a high resolution/low resolution training pair as input into a neural network 290 to train the neural network 290 to reverse the effects of pixelization and degraded lateral resolution in a 3D-SIM image data as illustrated in FIG. 1B. After application of the trained neural network 290 to a degraded 3D-SIM image, axial resolution of the image data may be improved, for example, along the Z axis.

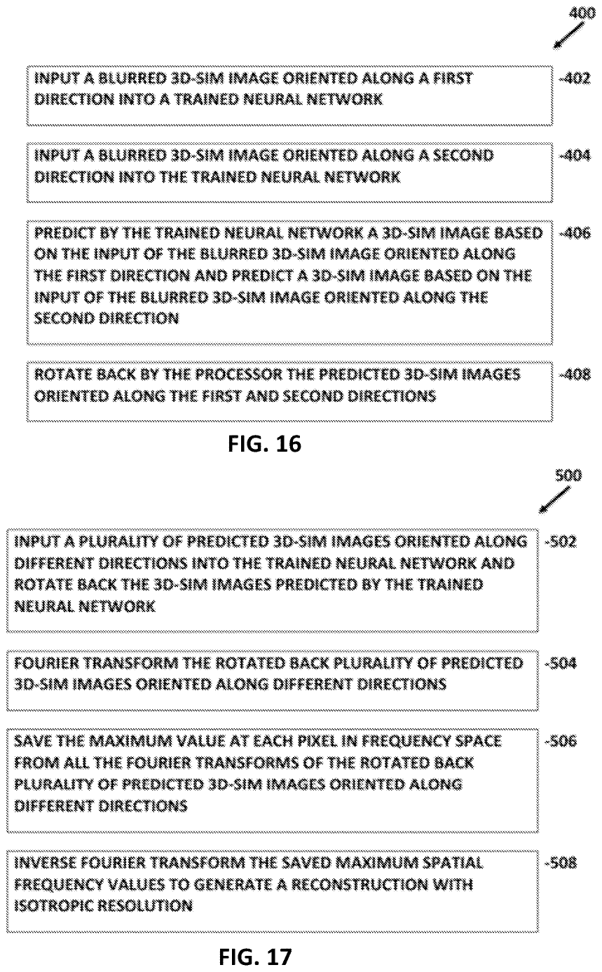

Referring to FIGS. 11 and 16, a process flow 400 is shown for the execution of the axial resolution improvement process/services 214 to perform resolution recovery at different rotations of the 3D-SIM image data by the trained neural network 290. At block 402, the processor 220 inputs blurred 3D-SIM image data oriented along a first direction, for example 0 degrees, into the trained neural network 290. At block 404, the processor 220 also inputs blurred 3D-SIM image data oriented along a second direction, for example 90 degrees, into the trained neural network 290. At block 406, the trained neural network 290 predicts reconstructed 3D-SIM images having improved axial resolution based on the input of the blurred 3D-SIM images rotated along the first and second directions, respectively. At block 408, the processor 220 rotates the predicted 3D-SIM images oriented along the first and second directions back into the original frame, thereby improving axial resolution along different directions. It should be noted that the predicted 3D-SIM image oriented along 0 degrees does not require rotation back into the original frame.

Referring to FIGS. 12 and 17, a process flow 500 is shown for the execution the axial resolution improvement process/services 214 to generate a reconstruction with improved axial and isotropic resolution when 3D-SIM image data is rotated along a plurality of different directions. At block 502, a plurality of predicted 3D-SIM images oriented at a plurality of different directions are inputted into the trained neural network 290 and then the predicted 3D-SIM images are rotated back to the original frame. At block 504, the processor 220 performs a Fourier Transform (as shown in FIG. 12) on each of the inputted predicted 3D-SIM images oriented along different directions. At block 506, the processor 220 saves the maximum value at each pixel in a frequency space derived from all respective predicted Fourier Transformed 3D-SIM images. At block 508, the processor 220 performs an inverse Fourier Transform to the saved maximum valued data at each pixel in frequency space to generate a reconstruction of the predicted 3D-SIM images having isotropic resolution. In some embodiments, six predicted 3D-SIM images may be oriented along directions of 0 degrees, 30 degrees, 60 degrees, 90 degrees, 120 degrees, and 150 degrees.

The present disclosure is directed to computational methods for improving axial resolution and thus resolution isotropy in 3D SIM. The computational methods disclosed herein enable better axial resolution with lower illumination intensity and requires only conventional 3D SIM systems without hardware modification.

### Results

### Four-beam Interference for Higher Axial Resolution

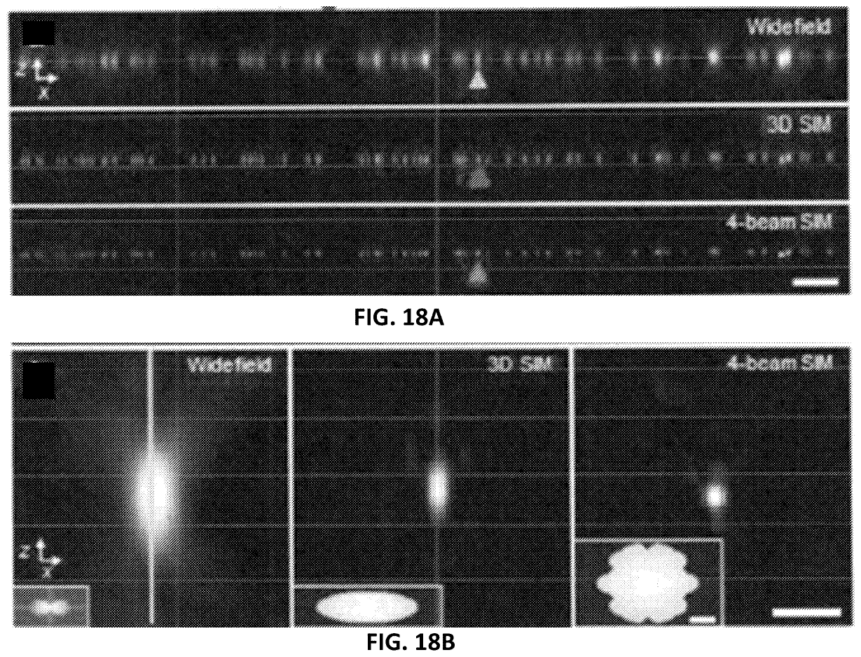

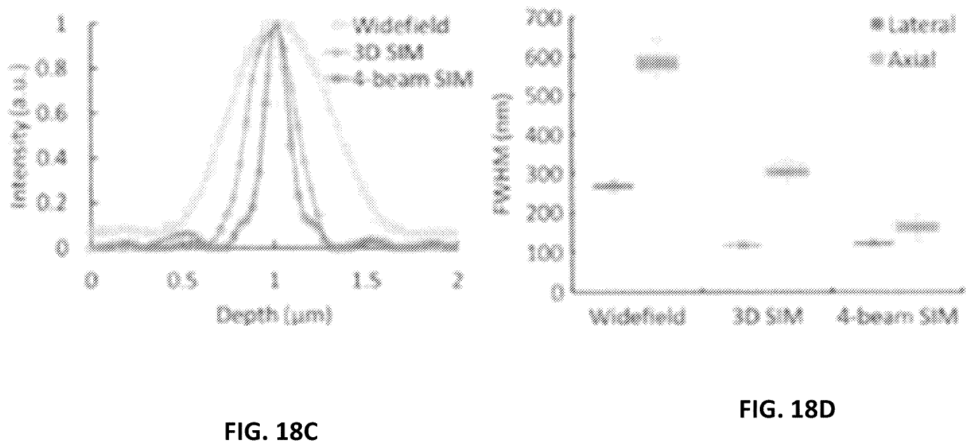

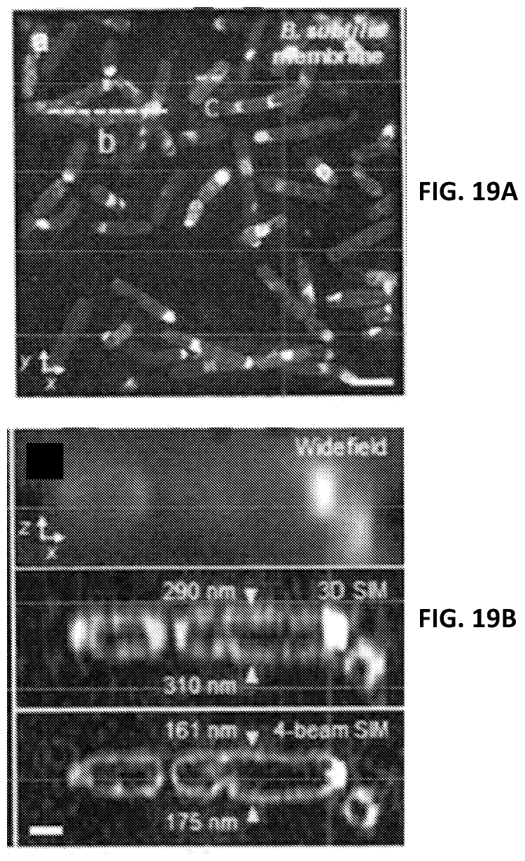

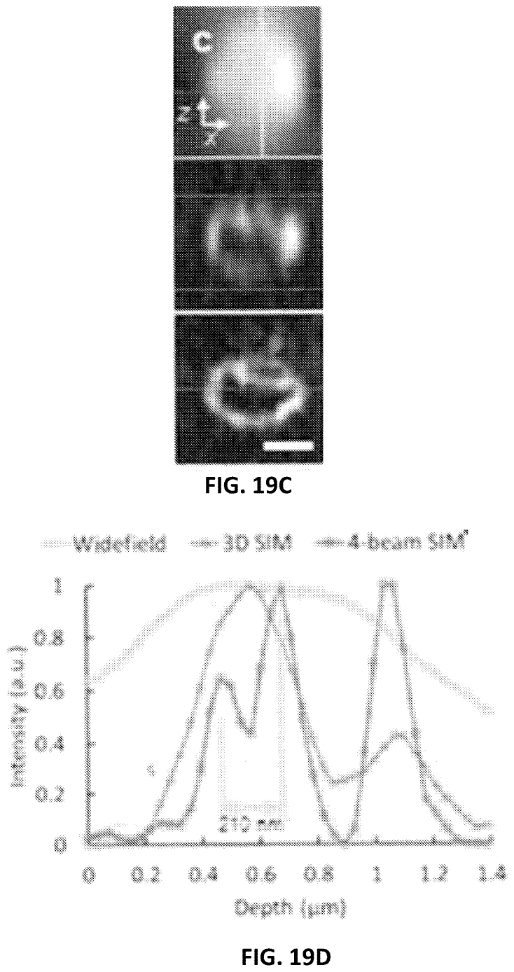

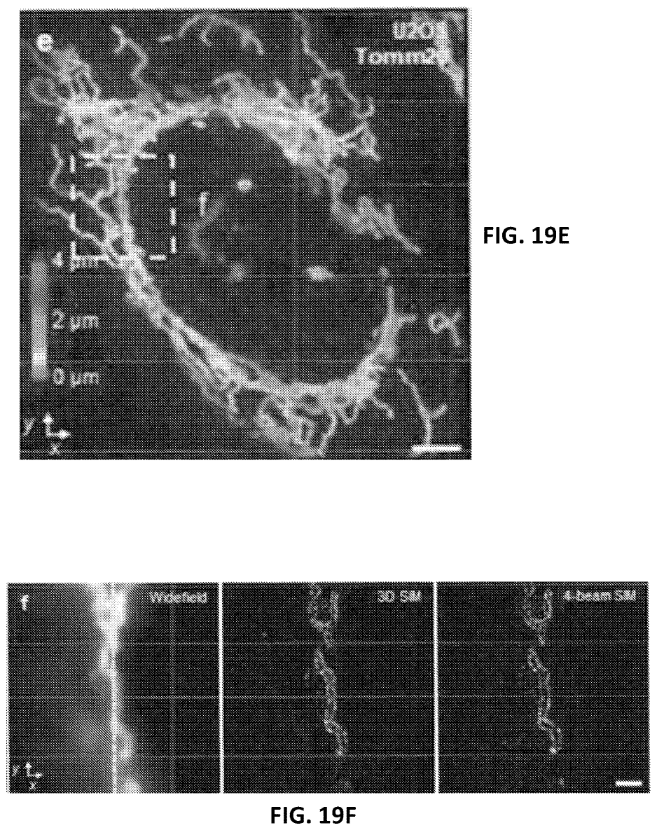

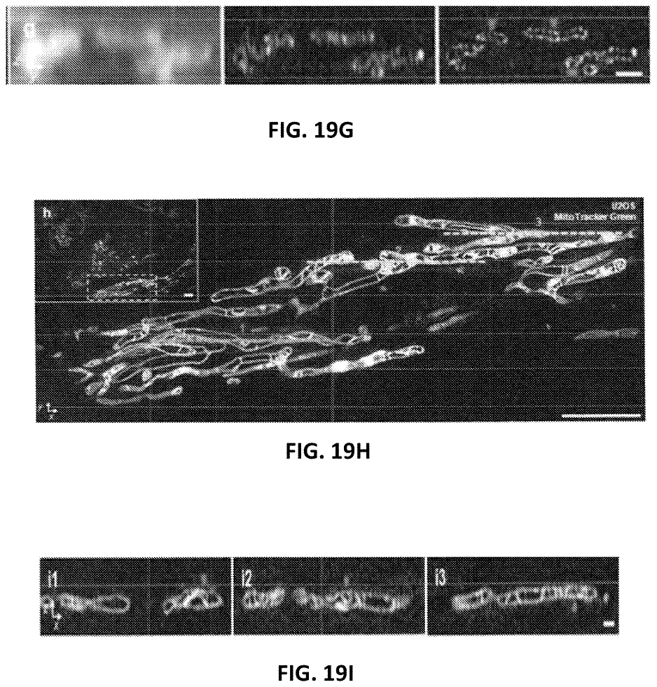

To demonstrate this method, a 3D SIM system was constructed that served as the base for testing the method, after using established protocols to confirm the quality of the illumination pattern and raw data. A piezoelectrically controlled mirror was then mounted and immersed directly over the sample, enabling 4-beam SIM. FIGS. 18, 19 illustrate test data and images regarding improving axial resolution in 3D SIM using the 4-beam SIM prototype.

100 nm yellow-green beads using the 1.35 NA objective were initially imaged to characterize the 4-beam SIM (FIGS. 18A and 18B). Using 45.6% iodixanol to match the RI of the silicone oil, thereby minimizing spherical aberration and focal shift, 15 images (5 phases per orientation, 3 orientations) were collected per plane and reconstructed image stacks similarly to conventional 3D SIM. As expected, 4-beam SIM maintained the ˜2-fold lateral resolution enhancement of 3D SIM over widefield microscopy (4-beam: 124+/−12 nm full width half maximum (FWHM), 3D SIM: 119+/−11 nm, widefield: 268+/−16 nm, N=99, 100, 102 measurements, respectively) while offering ˜2-fold better axial resolution than 3D SIM (4 beam: 163+/−13 nm, 3D SIM: 301+/−13 nm, widefield: 581+/−23 nm, FIGS. 18C and 18D). Similar results were obtained using a 1.27 NA water lens.

These resolution gains were then verified on biological samples. FIG. 19A shows four-beam SIM maximum intensity projections of live vegetative B. subtilis stained with CellBrite Fix 488, marking cell membranes. FIGS. 19B and 19C are axial views taken along the dotted lines (FIG. 19A) of the membranes taken with wide field microscopy (top), 3D SIM (middle), and four-beam SIM (bottom), respectively. FIG. 19B highlights the upper and lower cell membranes with red arrowheads highlighting membrane invagination. FIG. 19D is a graphical representation showing the line profiles corresponding to the orange line shown in FIG. 19C. FIG. 19E is an maximum intensity projection image of fixed U2OS cell labed with Tomm20 primary and rabbit-AlexaFluor 488 secondary antibodies, marking the outer mitochondrial membrane. The image shown was depth cooled as indicated. FIG. 19F are higher magnification lateral views (single plane views) corresponding to the white dashed rectangle in FIG. 19E as taken by widefield microscopy (left), 3D SIM (middle), and four-beam SIM (right) are shown. Similarly, FIG. 19G shows corresponding axial views taken across the vertical yellow dashed line in FIG. 19F with the red arrowheads highlighting void regions obscured in 3D SIM and widefield microscopy. FIG. 19H is higher magnification view along a single lateral plane of mitochondria labeled with Mito Tracker Green FM in a live U2OS cell highlighting the inner mitochondrial substructure within the mitochondria as indicated by the red arrowheads. FIG. 19I shows axial cross-sectional views taken along the green, orange, and yellow dashed lines shown in FIG. 19H that highlights the fine substructure within the mitochondria indicated by the red arrowheads. All test data were acquired with a 1.35 NA silicone immersion objective, with the samples index-matched in 45.6% iodixanol. Scale bars were 2 μm in FIG. 19A, 500 nm in FIGS. 19B, 19C, and FIG. 19I, 4 μm in FIGS. 19E and 19H, and 1 μm in FIGS. 19F and 19G. In all of these examples, the improved axial resolution offered by 4-beam SIM enabled discernment of fine features obscured in widefield microscopy and 3D SIM.

### An Improved Deep Learning Method Provides an Alternate Means to Improve Axial Resolution

Given that 3D SIM introduces less dose than 4-beam SIM, is more robust to wavefront distortions, and has been shown to enable sustained 4D imaging, computational strategies were considered for improving the axial resolution of 3D SIM without introducing additional illumination dose. As deep learning has been shown capable of enhancing spatial resolution in fluorescence microscopy, a method was evaluated that improved axial resolution by i) blurring and downsampling lateral views to resemble lower resolution axial views and ii) learning to reverse this degradation based on the higher resolution lateral view ground truth.

However, when the inventors attempted to restore 3D SIM data using this method, although the network improved axial resolution for some structures, it also artificially distorted the shape or even lost other structures, likely because axial specimen views looked quite different than the lateral specimen views the network was trained on. It was reasoned that network output could be improved if the network was directly exposed to axial information during the training process.

The network with axial (xz) 3D SIM views was used that had been blurred and downsampled to yield data with isotropic resolution equivalent to that of the axial resolution of 3D SIM. The network was then trained to reverse the degradation along the lateral direction, for which higher resolution ground truth exists. Applying the trained network on six digitally rotated views of unseen, similarly degraded 3D SIM data then enabled the improvement of one-dimensional resolution along arbitrary directions. Fusing all such resolution-enhanced views so that the best resolution in each view was preserved yielded a final prediction with isotropic resolution.

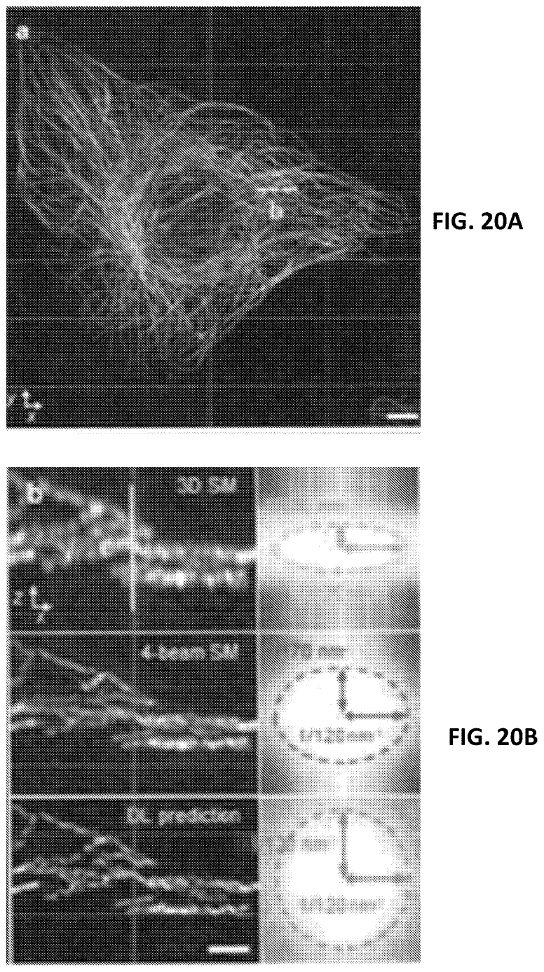

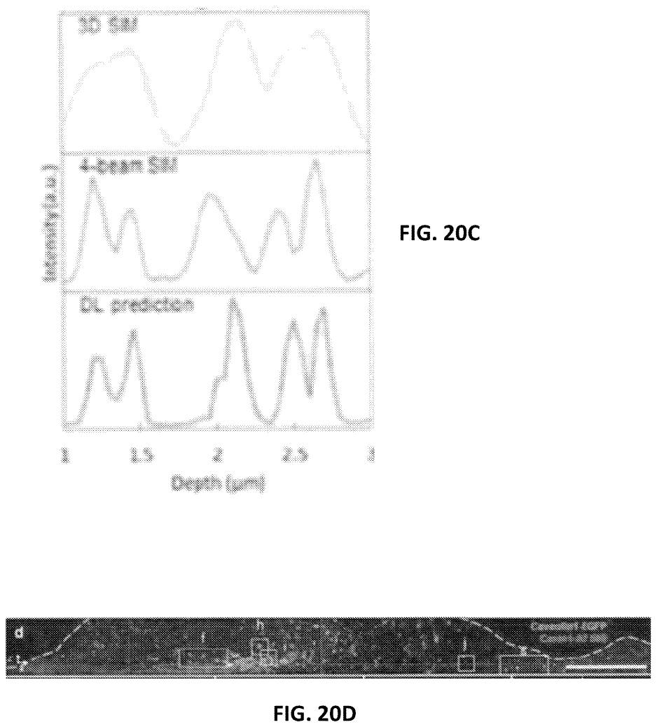

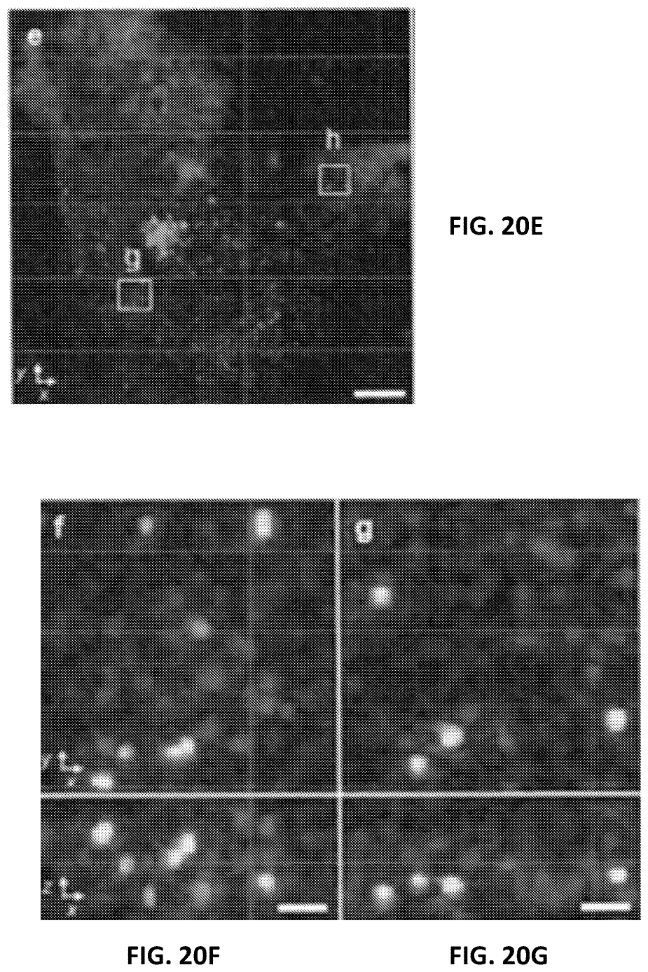

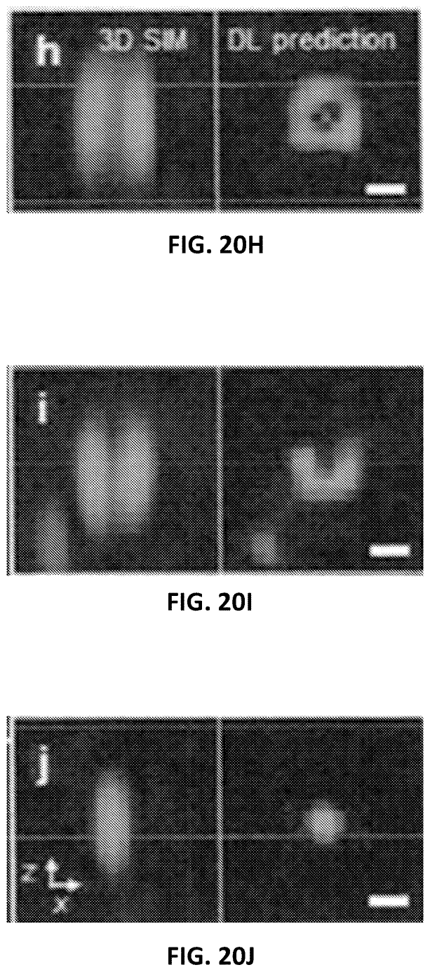

Comparing images of the same sample produced by 3D SIM, 4-beam SIM, and the modified deep learning prediction (FIGS. 20A-20C) validated the deep learning method. For example, when inspecting immunolabeled microtubules in fixed U2OS cells (FIG. 20A), although all three methods offered similar lateral resolution (FIG. 20B), fine axial features blurred in 3D SIM were resolved with 4-beam SIM and the network prediction, which showed close visual (FIG. 20B) and quantitative (FIG. 20C) agreement. Similar results were obtained on membrane-stained, live B. subtilis and immunolabeled Tomm20 in fixed U2OS cells.

Next, two-color imaging of Caveolin-1 and Cavin-1, components of the caveolar coat, was performed. Caveolae are 70-100 nm diameter membrane invaginations that can detach from the plasma membrane and move through the cytoplasm, playing key roles in lipid metabolism and trafficking. Fixed mouse embryonic fibroblasts expressing Caveolin-1-EGFP and additionally immunolabeled Cavin-1 with Alexa Fluor 568 were imaged with 3D SIM,, and the deep learning approach applied to the 3D SIM images (FIGS. 20D-20J). Caveolin-1 and Cavin-1 labels mostly marked distinct caveolae pools (FIGS. 20D and 20E), although a smaller pool of caveolae puncta that displayed colocalized signal were also observed (FIGS. 20F and 20G). Unlike the Cavin-1 signal, which mostly decorated structures sized at or below our resolution limit, Caveolin-1 appeared to label a more heterogenous pool of caveolae (FIGS. 20H-20J). Hints of such heterogeneity existed in the input 3D SIM data; however, were obscured by diffraction. By contrast, the network prediction appeared to resolve ring-shaped structures (FIG. 20H), partial rings (FIG. 20I), and spherical puncta (FIG. 20J). It was also found that Caveolin-1 localized to larger ring-shaped structures of varying size, possibly lipid droplets.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

1. A three-dimensional structured illumination microscopy system comprising:
at least one illumination source for transmitting a respective illumination beam through an acoustic-optic tunable filter for producing a combined laser beam;
a pair of lenses in communication with a pinhole for generating a beam expander that expands and spatially filters the combined laser beam;
a spatial light modulator for producing an illumination pattern of three illumination beams;
an objective in communication with the spatial light modulator such that the three illumination beams are re-imaged to the back focal plane of the objective as off-axis illumination beams and an on-axis central illumination beam; and
a mirror positioned in diametric opposition to the objective such that the on-axis central illumination beam is reflected back towards the objective as an on-axis reflected illumination beam to generate a four-beam interference pattern at the sample plane.

2. The system of claim 1, further comprising:
a liquid crystal polarization rotator in communication between a pupil mask and the spatial light modulator, the liquid crystal polarization rotator being operable to rotate the polarization of the three illumination beams to maximize interference contrast at the sample plane.

3. The system of claim 2, wherein the liquid crystal polarization rotator is operable to rotate the polarization of the three illumination beams at the sample plane.

4. The system of claim 2, further comprising:
a pupil mask is operable to filter the three illumination beams to remove spurious patterns.

5. The system of claim 1, further comprising:
a dichroic mirror in communication between the spatial light modulator and the objective lens, the dichroic mirror being operable for separating the three illumination beams from fluorescence emissions emitted by the sample.

6. The system of claim 1, further comprising:
a camera for detecting the fluorescence emissions generated by the four-beam interference pattern at the sample plane.

7. The system of claim 2, wherein the illumination pattern of three illumination beams are Fourier transformed prior to the polarization of the three illumination beams being rotated by the liquid crystal polarization rotator.

8. The system of claim 1, wherein the on-axis reflected illumination beam is a coherent beam.

9. The system of claim 1, wherein the illumination pattern generated by the spatial light modulator produces five phases and three orientations.

10. A method of improving spatial resolution in a three-dimensional structured illumination microscopy system (3D-SIM) comprising:
generating an illumination pattern of three illumination beams by the 3D-SIM system;
imaging the illumination pattern of three illumination beams to a back focal plane of an objective such that the three illumination beams comprise first and second off-axis illumination beams and an on-axis central illumination beam relative to a sample plane;
reflecting the on-axis central illumination beam off a mirror positioned in diametric opposition to the objective such that an on-axis reflected illumination beam is reflected directly back towards the objective and sample plane; and
generating a four-beam interference pattern by the first off-axis illumination beam, the second off-axis illumination beam, the on-axis central illumination beam, and the on-axis reflected illumination beam at the sample plane.

11. The system of claim 10, wherein the on-axis reflected illumination beam is a coherent beam.

12. The system of claim 10, wherein the three illumination beams comprise five phases and three orientations.

13. The system of claim 10, wherein the three illumination beams are polarized.

14. The system of claim 13, wherein the polarization of the three illumination beams is rotated to maximize interference of the illumination pattern at the sample plane.

15. A system for training a neural network for improving axial resolution comprising:
a computing system including a processor in communication with a memory, the memory including instructions, which, when executed, cause the processor to:
obtain a 3D-SIM image;
blur the 3D-SIM image along a first axial direction to suppress artifacts;
blur the 3D-SIM image blurred along the first axial direction along a second lateral direction;
downsample the 3D-SIM image blurred along the first and second directions; and
upsample the 3D-SIM image blurred along the first and second directions to produce a low resolution 3D-SIM image.

16. (canceled)

17. (canceled)

18. The system of claim 15, wherein the memory further includes instructions, which, when executed, cause the processor to:
repeat the operations of claim 15 to generate a plurality of low resolution and high resolution 3D-SIM image training pairs; and
input the plurality of low resolution and high resolution 3D-SIM image training pairs into a neural network, wherein inputting the plurality of low resolution and high resolution 3D-SIM image training pairs trains the neural network to predict and reconstruct a 3D-SIM image based on a low resolution 3D-SIM image evaluated by the trained neural network.

19. (canceled)

20. (canceled)

21. (canceled)

22. The system of claim 18, wherein the memory further includes instructions, which, when executed, cause the processor to:
input a low-resolution 3D-SIM image oriented along a first direction into the trained neural network; and
input a low-resolution 3D-SIM image oriented along a second direction into the trained neural network.

23. (canceled)

24. The system of claim 22, wherein the memory further includes instructions, which, when executed, cause the processor to:
predict by the trained neural network a 3D-SIM image based on the input of the low-resolution 3D-SIM image oriented along the first direction and predict a 3D-SIM image based on the input of the low-resolution 3D-SIM image oriented along the second direction and
rotate back the predicted 3D-SIM image oriented along the first and second directions to an original frame.

25. The system of claim 18, wherein the memory further includes instructions, which, when executed, cause the processor to:
input a plurality of predicted 3D-SIM images oriented along different directions into the trained neutral network;
Fourier Transform the inputted plurality of predicted 3D-SIM images oriented along different directions; and
save in the memory the maximum value of each of the inputted Fourier Transformed predicted 3D-SIM images oriented along different directions.

26. (canceled)

27. (canceled)

28. The system of claim 25, wherein the memory further includes instructions, which, when executed, cause the processor to:
Inverse Fourier Transform the saved maximum valued data in frequency space to generate a reconstruction of the 3D-SIM image having isotropic resolution.
